(19) United States
(12) Patent Application Publication
(10) Pub. No.: US 2011/0015985 A1
(43) Pub. Date: Jan. 20, 2011

(54) UNIVERSAL MULTIMEDIA DISTRIBUTION, STORAGE, AND PLAYBACK SYSTEMS AND METHODS

(76) Inventor: James Curtis, Dallas, TX (US)

Correspondence Address: CARSTENS & CAHOON, LLP, 13760 NOEL ROAD, SUITE 900, DALLAS, TX, 75240, US

(21) Appl. No.: 12/505,342

(22) Filed: Jul. 17, 2009

(51) Int. Cl. G06Q 50/00; G06F 15/16; G06F 12/14; G06F 13/00; G06F 7/00

(52) U.S. Cl. 705/14.37; 705/14.66; 705/14.65; 709/203; 713/193; 710/301; 707/E17.032; 707/E17.009

(57) ABSTRACT

Universal multimedia distribution, storage, and playback systems, devices, and methods are disclosed herein. A media distribution kiosk located at a retail establishment provides a user with access to a multitude of different forms of digital multimedia that may be purchased and downloaded onto a portable media transporter device. The portable media transporter device may then be inserted into a media storage and playback device that is capable of transcoding and storing the media on a hard disk drive. Additionally, the media storage and playback device is capable of transcoding, storing, and playing information residing on various other media formats such as DVD (movies, audio, gaming software), CD, and memory cards. Digital rights management (DRM) security measures employed at the kiosk and at the transporter and storage/playback devices ensure the integrity of the media transferred to the user.

### BACKGROUND OF THE INVENTION

1. Field of the invention

The invention relates generally to digital multimedia content, and more specifically to devices, systems, and methods for distributing, transporting, storing, and playback of multimedia content.

2. Description of the Related Art

In recent years, consumers of digital media have seen a growing proliferation of various types of devices and systems for accessing, storing, and viewing multimedia content that is acquired via data networks such as the Internet. For example, a number of online media distributors offer consumers having internet access, the ability to purchase and download video and audio content via proprietary software that is connected to large content databases. The proprietary software permits consumers to store the media content on personal electronic devices such as a personal computer, laptop computer, personal digital assistant (PDA), personal media player, or mobile phone. Consumers may then play the content on such devices or transfer the content to other devices for storage and playback.

However, persons in approximately forty percent of households in the United States are not able to access the Internet via broadband. In fact, many households do not have access to the Internet at all. As a result, it is much more burdensome or impossible for individuals living in such households to acquire media content through the Internet. The majority of consumers not having Internet access but desiring to acquire and use digital multimedia content have until recently, had only a few available options. One option is that media content can be purchased, or rented from a retail establishment located at a site physically remote from the consumer's home. After acquiring the media, the consumer can view and/or listen to the content via a portable or fixed playback device. In the case of media acquired via rental, the media must be returned by the consumer, an often burdensome task.

Equally burdensome for the consumer who purchases media is the task of storing said media in an orderly manner and protecting it from being damaged. Because most media is still distributed in physical media device formats such as DVDs and CDs (containing video, audio, and gaming products), most consumers have accumulated a substantial number of purchased discs and other assorted media that is stored, in a disorganized manner and is often unprotected from damage in the consumer's household. Devices and other systems disclosed in the prior art have sought to improve upon the means by which consumers acquire, store, and playback multimedia content.

One such system is disclosed in U.S. Patent Publication No. 2009/0117846 A1, published on May 7, 2009, and assigned to Apple, Inc. (hereinafter “the Apple '846 publication”). The Apple '846 publication discloses systems and methods that enable a media distribution system to distribute media content to a media device via one or more media distribution kiosks that are connected via a data network to a centralized media storage server. In particular, the Apple '846 publication teaches a portable media device that is configured to establish, a connection (wired or wirelessly) to a media distribution kiosk so as to allow a consumer to purchase media content and download it onto his or her portable media device. The portable media device taught by the Apple '846 publication is capable of uploading media to a remote host or other client system.

Other devices disclosed in the prior art, such as the KALEIDESCAPE® 1080p Player (as configured at the time of the Sling of this application) (see http;//www.kaleidescape.com), are configured to permit consumers to insert optical discs such as DVDs and CDs into a player device which is capable of decrypting the information residing on the discs and storing a copy of the information onto a local or external storage drive. These prior art devices also provide users with easy to use navigational menus for accessing and playing the stored media. The foregoing capability allows consumers to store the media contained on their amassed collection of optical discs into one easily accessible system. However, one drawback of these prior art media player/storage devices is that they are not capable of communicating with a portable media storage device such as might be used in connection with the media distribution system taught by the Apple '846 publication, hi fact, such systems are only capable of accessing media, stored on optical discs or via data networks.

Other systems for media distribution found in the prior art suffer from similar drawbacks. One such system is the digital media distribution system disclosed in U.S. Patent Publication No. 2004/0254940 A1, published on Dec. 16, 2004, and naming Hector Cesar Brush as the inventor (hereinafter “the Brush '940 publication”). The Brush '940 publication teaches a media distribution kiosk similar to that which is taught by the Apple '846 publication. A portable digital media card is disclosed, that is capable of communicating with the media distribution kiosk such that media is transferred to said media card. The Brush '940 publication further teaches a media player that is capable of receiving, reading, and storing the information residing on the portable digital, media card. One drawback, of the system taught by the Brush '940 publication is that the media player disclosed therein is not capable of receiving and reading optical discs. As discussed above, most consumers have a substantial collection of DVDs and CDs. The media player taught by the Brush '940 publication would not be capable of playing such DVDs or CDs, which would require consumers to use a separate player for playback of such media. It is the object of the invention disclosed herein to remedy these and other deficiencies found in the prior art.

### BRIEF SUMMARY OF THE INVENTION

Accordingly, there is provided herein, in various embodiments, systems, methods, and devices that enable a multimedia distribution system to transfer media residing on a centralized database, to one or more media distribution kiosks located at retail locations or other desirable venues. A media transporter device capable of communicating with the kiosks allows a user to store media “downloaded” from said kiosks. The portable transporter device may then be used to transport the media stored therein to a user's home or other venue for playback. A media storage and playback device having a dock for receiving the transporter device, communicates with said transporter device and transfers the media stored on said transporter device to the playback device. Farther the playback device is configured to accept optical discs such as DVDs and CDs (movies, music, gaming, etc.), to read the media data from such discs using data decryption techniques, to store such media data, and to playback the media data in the manner for which it was intended.

In one aspect of the invention, the media distribution kiosk is connected, via a data network, to a media storage server that is configured to access media content storage systems. The kiosk is also connected, via a data network, to a business server that processes financial information provided by the consumer in order to purchase the desired media content. Hie kiosk is capable of establishing a wireless or physical connection, with the media transporter device for the purposes of communication between the two devices. Once connected, a user may use a graphic user interface (GUI) displayed by the kiosk, or alternatively, a GUI displayed by the media transporter device, to select media content that the user desires to purchase and download, information identifying the user and the financial means by which the user will purchase the media content is provided by the user and is communicated to the business server. The business server will approve or reject the proposed transaction. If approved, the media storage server will retrieve the desired media content and transfer said content to the kiosk for further transfer to the media transporter device.

In a further aspect of the invention, the portable media transporter device is suitable for storing digital multimedia files including, movies, music, video games, photos, and other types of date. The transporter device includes security keys and other information necessary to perform protocols for authentication and encryption/decryption with the kiosk and media playback device. The media distribution system may utilize a digital rights management (DRM) system to ensure that media content used in connection with the system is not the subject of unauthorized copying or other uses not authorized by the owner of the intellectual property rights in the content.

In yet a further aspect of the invention, the media storage and playback device is capable of transcoding data read from optical discs such as DVDs and CDs, the media transport device, and any other data sources with which the media storage and playback device communicates. The media storage and playback device contains an internal and/or external storage system upon which the data is written and from which can later be retrieved for use. The media storage and playback device, which is configured to connect to a media display device such as a television or projector, is capable of performing playback of video (movies, television, gaming software, etc.), audio (music, audio books, etc.), and any other digital images (photographs, HTML files, etc.). Those skilled in the art will appreciate that multiple displays may be utilized to playback, distinct media content simultaneously. The media storage and playback device is also capable of communicating with a plurality of peripheral devices such as cameras, scanners, printers, remote control devices, and gaming controls (joysticks, etc.). The media storage and playback device is enabled to communicate with data networks such the Internet, allowing for user access to the World Wide Web, email, and other systems configured for distribution of media content through the data network. The media storage and playback device's ability to communicate with data networks also allows for communication with digital rights management and encryption management systems.

In another aspect of the invention, methods for media distribution are disclosed. Taught herein are methods for using a media distribution kiosk connected to a business server via a data network, to identity a user and his or her purchasing preferences and to provide the user with promotional materials (at the kiosk) such as coupons that are associated with said preferences or with products or services provided at the retail establishment where the kiosk is located. Other methods for media distribution taught herein include a method for transferring advertising material to a user along with the media, content purchased such that if the user views the advertising material, information confirming such use will be communicated to the business server via data networks and said user can earn credits towards discounts on media or other products. In yet another method for media distribution taught herein, a user is provided with a social networking software application that enables the user and his or her peers to share with one another, their media preferences (favorite movies, music, games, etc.). Based upon the preferences of a user's peers, the user, using the social networking application, can set forth his or her list of media desired for purchase or rental. Information associated with the aforesaid list of desired media may be stored on the aforementioned media transport device or the media storage and playback device, which may then be communicated to the kiosk. One or more of the desired media items identified on the aforesaid list may then he transferred to the media transport device or media storage and playback device for later viewing.

### BRIEF DESCRIPTION OF THE SEVERAL VIEWS OF THE DRAWINGS

A more complete understanding of the universal multimedia, distribution, storage, and playback systems and methods of the present invention may be had by reference to the following detailed description when taken in conjunction with the accompanying drawings, wherein:

FIG. 1 is a block diagram of a preferred embodiment of the universal multimedia distribution, storage, and playback system of the present invention;

FIG. 2 shows a perspective view of a preferred embodiment of the media distribution kiosk of the universal multimedia distribution, storage, and playback system of the present invention;

FIG. 3 shows a perspective view of a preferred embodiment of the portable media transporter device of the universal multimedia distribution, storage, and playback system of the present invention;

FIG. 4 shows an alternate embodiment of a portable media transporter device of the universal multimedia distribution, storage, and playback system of the present invention;

FIG. 5 is a block diagram providing a general overview of the hardware and capabilities of a preferred embodiment of the media storage and playback device of the universal multimedia distribution, storage, and playback system of the present invention;

FIG. 6 is a block diagram of a preferred embodiment of the hardware associated with the media storage and playback device of the universal multimedia distribution, storage, and playback system of the present invention; and

FIG. 7 is a block diagram of a preferred embodiment of the software associated with the media storage and playback device of the universal multimedia distribution, storage, and playback system of the present invention.

Where used in the various figures of the drawings, the same numerals designate the same or similar parts. Furthermore, when the terms “top,” “bottom,” “first,” “second,” “upper,” “lower,” “height,” “outer,” “inner,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific width, length, and similar requirements will likewise be within the skill of the art after the following teachings of the present invention have been read and understood.

Preferred embodiments of the universal multimedia distribution, storage, and playback systems and methods according to the present invention will, now be described in detail with reference to the accompanying drawings.

### DETAILED DESCRIPTION OF THE INVENTION

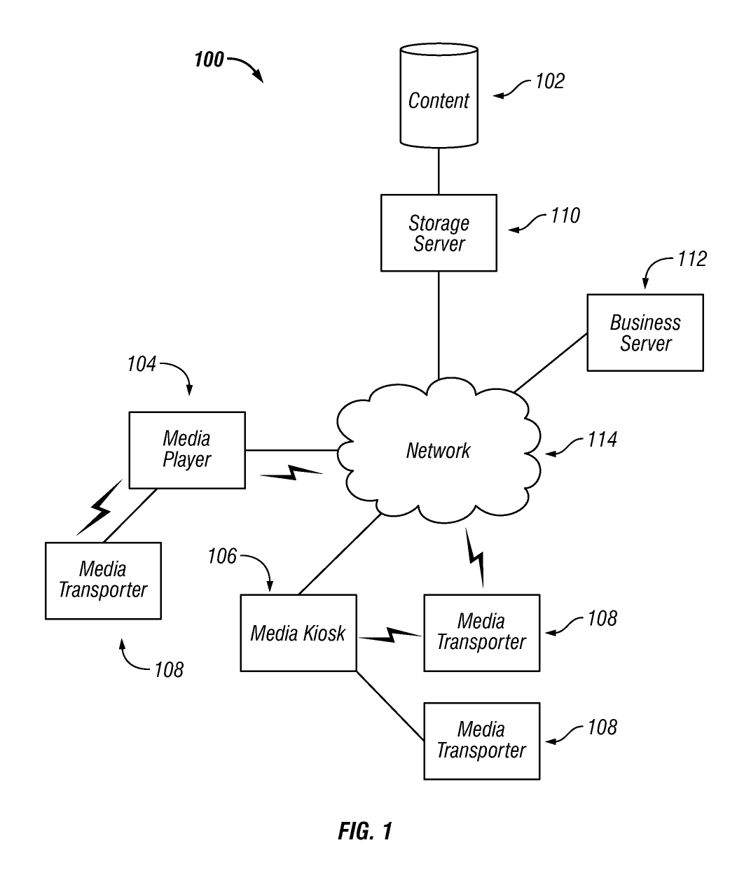

Referring to FIG. 1, a block diagram of a preferred embodiment, of the universal multimedia distribution, storage, and playback system 100 of the present invention. The system 100 includes one or more media distribution kiosks 106 that may be placed at diverse commercially advantageous physical locations such as retail establishments, transportation hubs (airports, bus and train stations, etc.), restaurants, and any other place where potential consumers may congregate. Users of the system seeking to access media content may do so through a media distribution kiosk 106. The media distribution kiosk 106 is connected to a data network 114.

It is contemplated that the data network 114 may include one or more of the Internet, a private network, mobile data network, satellite network, a public switched telephone network (PSTN), or any other network capable handling the communication of information. Although the media distribution kiosk 106 of the preferred embodiment communicates with the data network 114 via a wired connection, it is contemplated that alternate embodiments of the kiosk 106 may be configured to communicate with the data network 114 via wireless means.

Media content 102 accessible for distribution to users of the system 100 resides in one or more storage systems 102 controlled by at least one storage server 110. Examples of media content 102 stored for distribution on the storage system 102 include, but are not limited to, movies, music, gaming software, ring tones, electronic books, audio books, media clips, and photographic images. The storage server 110 is electronically coupled to the kiosk via the data network 114, providing for communications with the media distribution kiosk 106.

The media distribution, kiosk 106 provides an interface through which a user may communicate with the data network 114 to access stored media content 102. As will be described in more detail below, the media distribution kiosk includes a display (with a graphical user interface) and controls (keyboard, touchscreen, trackball, etc.) that enable the user to interact with the kiosk. When a user initiates contact with the media distribution kiosk 106, information is provided to the kiosk by the user or a device controlled by the user that identifies the user and other information associated with the user. Such information may include user's financial information (credit card and bank account information), the user's media preferences (types of movies or song genres preferred), the user's purchasing history, and any discounts or credits that the user may be able to allocate to future purchases. This user information is then transmitted to a business server 112 connected to the data network 114.

The kiosk 106 includes a browser application, that permits the user to navigate menus of a virtual media store residing on the business server 112 and accessible through the kiosk 106. The browser permits users to locate desirable media. When desirable media, is found by the user, the user may elect to purchase or otherwise acquire (rental, license, etc.) a copy of the media for download. The business server determines whether to authorize the user's request to download media based upon the information provided by the user and other financial information obtained through the data network or residing within the business server itself. If the business server determines that the requested download should be authorized, the business server then authorizes the user to download the media.

The media distribution kiosk 106 is configured to communicate with a media transporter device 108 that is capable of docking with the kiosk 106 and is used to store and transport media content for further use by the user. The media transporter device 108 may contain information pertaining to the user that may be exchanged with the media distribution kiosk 106 to enable identification of the user and to facilitate the handling of financial Information needed to gain authorization to acquire media. Although the preferred embodiment of the media transporter device 108 functions primarily as a data storage device, alternate embodiments may include devices that are capable of providing the user with the ability to browse the virtual media store wirelessly by using the device and to download and play the media on said device. Such an alternate embodiment will be disclosed below with reference to FIG. 4.

Once a download is authorized by the business server 112, the storage server 110 acquires the selected media and transmits it to the kiosk 106 for download to the user's media transporter device. The kiosk 106 then transmits the media to the media transporter device 108, which is docked to said kiosk 106. The user may continue in the manner described above to select additional media for download or terminate his or her session with the media distribution kiosk. 106. The media transporter device, in its preferred embodiment is small enough that it is easily portable by the user, allowing the user to transport it elsewhere for further use.

Still referring to FIG. 1, the universal multimedia distribution, storage, and playback system 100 of the present invention includes a media storage and playback device 104 that is capable of exchanging information with the media transporter device 108. The media storage and playback device 104 includes at least one means for receiving the media transporter device such that communication may occur between the two devices. In the presently preferred embodiment, a PCMCIA slot integrated into the media storage and playback device, which is further connected to an eSATA port, provides the means receiving the media transporter device such that communication may occur between the two devices. Information read from the media transporter device 106 is stored in data storage systems (either internal or external to the media storage and playback device) accessible by the media, storage and playback device 104. The media storage and playback device 104 is capable of acquiring information from other media formats such as optical discs, secure digital (SD) cards, memory sticks, compact flash cards, and USB flash drives. The media storage and playback device 104 is capable of transcoding information stored on media having copy protection systems that are configured to prevent unauthorized copying. Such copy protection, systems include Content Scrambling System (CSS) and Advanced Access Content System (AACS). Once transcoded, the information is stored to the storage system(s) accessible by the media storage and playback device 104.

The media storage and playback device 104 is also capable of exchanging information with other devices such digital cameras, video cameras, scanners, printers, personal computers, personal digital assistants (PDAs), and mobile phones. Further, the media storage and playback device 104 is capable of communicating with one or more data networks 114 for various purposes such as to download programming content, to download media via the business server, online gaming, email, and to access the World Wide Web (WWW).

The media storage and playback device 104 includes software applications capable of providing a user with interactive menus for accessing stored media, for obtaining television programming information, for accessing the WWW, for navigating the virtual media store, for recording television. Playback of media is accomplished via peripheral devices such as one or more televisions, monitors, projectors, speakers, and/or any other devices adapted for such purposes.

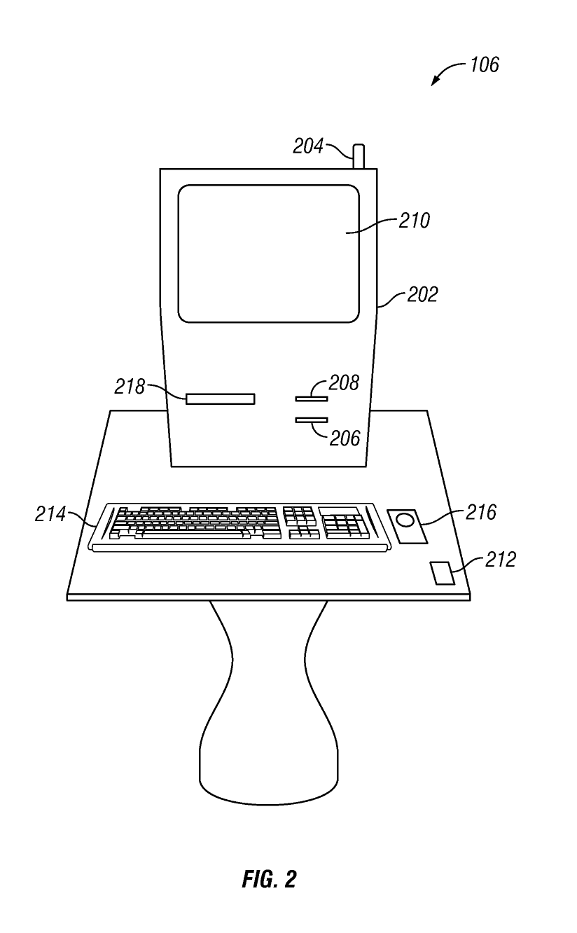

Referring now to FIG. 2, a perspective view of a preferred embodiment of the media distribution kiosk 106 of the universal, multimedia distribution, storage, and playback system 100 of the present invention. The kiosk 106 shown in the preferred embodiment, includes a stand-alone housing 202 that is similar in form to a personal computer or automatic teller machine (ATM) but it should be understood that alternate embodiments may have a form that is substantially different. For example, an alternate embodiment of the kiosk 106 may be installed as a panel, flush with a wall (not shown), or any other means for mounting.

The kiosk 106 includes a display 210, permitting the user to visually perceive a graphical user interface (GUI) (not shown) that may be navigated via controllers such as a keyboard 214 and trackball 216. Alternate embodiments of the kiosk 106 may also be capable of providing a touchscreen interface for the user to use as a means for interacting with said kiosk 106. The kiosk 106 further includes a docking port 206 for receiving the media transporter device 108.

Although the preferred embodiment of the media transporter device 108 is coupled to the kiosk 106 via the aforementioned docking port 206, alternate embodiments of the media transporter device (hereinafter a “smart media transporter device”) are capable of establishing a virtual, wireless dock with the kiosk 106. A sensor 212 located on the kiosk 106 is capable of determining that a smart media transporter device is within close proximity to the kiosk 106. Once a smart media transporter device is within a suitable range, the device is authenticated as an authorized device and a connection is established between the kiosk and the device. An antenna 204 located on the kiosk provides for transmission and reception of data signals between a smart device and the kiosk. The antenna 204 may also provide for transmission and reception of signals between the kiosk 106 and a data network 114.

If is contemplated that most users of the system of the present invention will provide financial information to the operator of the system to permit for convenient financial transactions. Such information may include credit or debit card information, bank account information, gift certificates, or any other manner by which money may be debited or credited to an account established for the user. However, the kiosk 106 will also be capable of reading credit/debit/gilt cards via a slot 208 located on the kiosk.

Another capability of the kiosk 106 is to dispense materials to the user via a dispensing slot 218. Various items may be dispensed through the aforesaid slot 218 including, but not limited to, media residing on optical discs, coupons, and other marketing/promotional materials. The foregoing items may be stored within the kiosk itself or in a location accessible by the kiosk. Any known mechanisms for dispensing sA printer (not shown) within the kiosk is used to print text and/or graphics on paper items to be dispensed to the user.

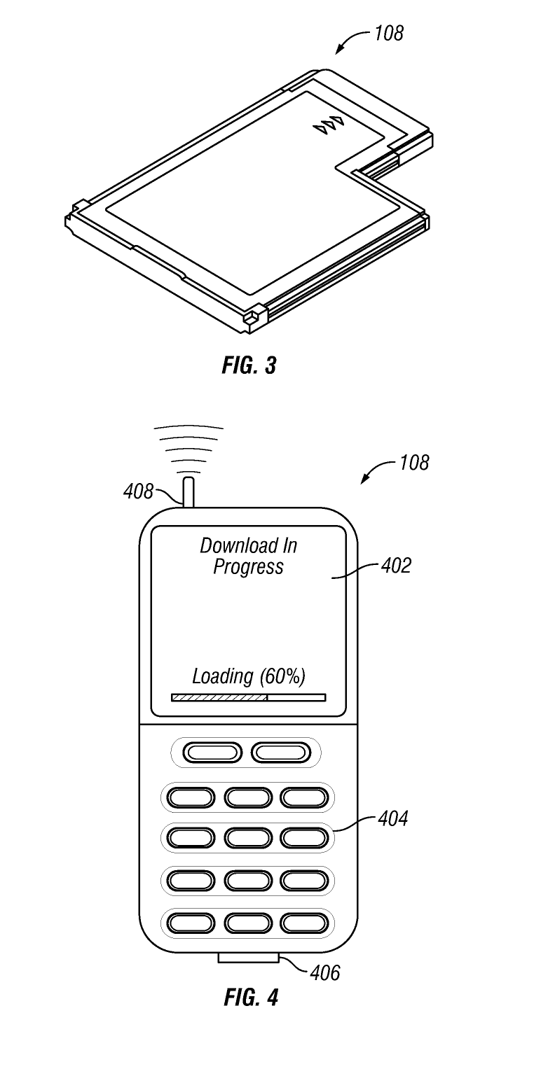

Referring now to FIG. 3, a perspective view of a preferred embodiment of the portable media transporter device 108 of the universal multimedia distribution, storage, and playback system of the present invention. The media transporter device 108 is capable of both storing media and other information on non-volatile memory, and also of communicating with the media distribution kiosk 106 and the media storage and playback device 104. Although the preferred embodiment of the transporter device is a 54 mm EXPRESSCARD® (see http://www.expresscard.org), a device well known to those of ordinary skill in the art, it is contemplated that any device having the foregoing capabilities may be used.

It is preferable that the transporter be of a size and form that is convenient for a user to carry on his or her person. The transporter should also have a storage capacity that is sufficiently large to contain at least one full length movie in high definition format. It should be apparent to those skilled in the art that alternate embodiments of the transporter may have memory capacities that vary in size but which are sufficient to contain movies, music, video games, and other media in quantities desired by the consumer.

Referring now to FIG. 4, an alternate embodiment of a portable media transporter

device of the universal multimedia distribution, storage, and playback system of the present invention. As described above, alternate embodiments of the media transporter device (“smart media transporter devices”) may have additional capabilities. The smart media transporter device 108 may include devices such as a cellular telephone, personal digital assistant (PDA), smart phone, laptop computer, mobile media player, or other device capable of wireless communications. The media device and kiosk taught by Apple '846 publication (US 2009/0117846 A1), incorporated by reference herein, describes an example of the type of devices that may function as the smart media transporter device and media distribution kiosk of the present invention.

The smart media transporter device 108 is equipped with a screen 402 and keypad 404 that permit a user to view and navigate a GUI displayed by said device. The smart media transporter includes a processor and software applications providing the device with the capability to playback media. The smart media transporter device also includes a wireless transceiver and is configured to wirelessly communicate with the media distribution kiosk, and media storage and playback device, and permits the user to utilize the GUI of the smart media transporter device to interact with the virtual media store. Alternatively, the smart media transporter device may wirelessly communicate with the business server and storage server without the necessity of interacting with the media distribution kiosk. However, such functionality may be disabled by the operator of the media distribution system, if it is desirable to require the user to be present at the location of the kiosk in order to download media. Further, should the ability of the smart media transporter device to wirelessly communicate be disabled, a communications port 406 located on the device is capable of coupling to a corresponding docking port on the kiosk such that the device and the kiosk can exchange information through said ports.

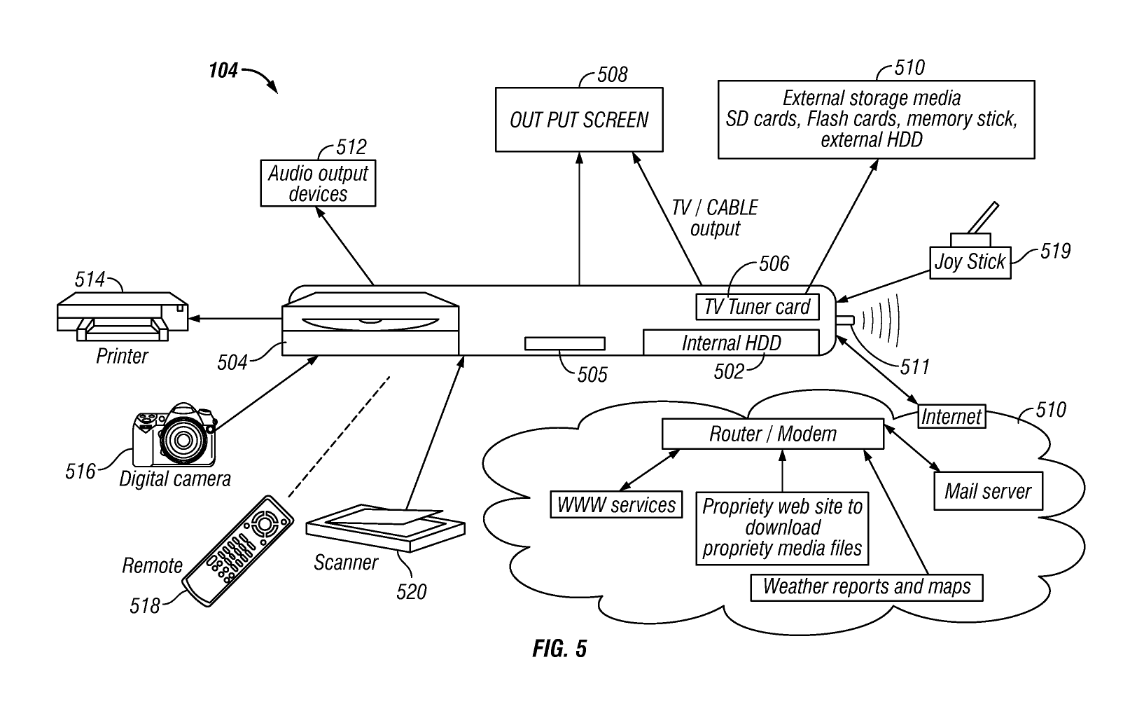

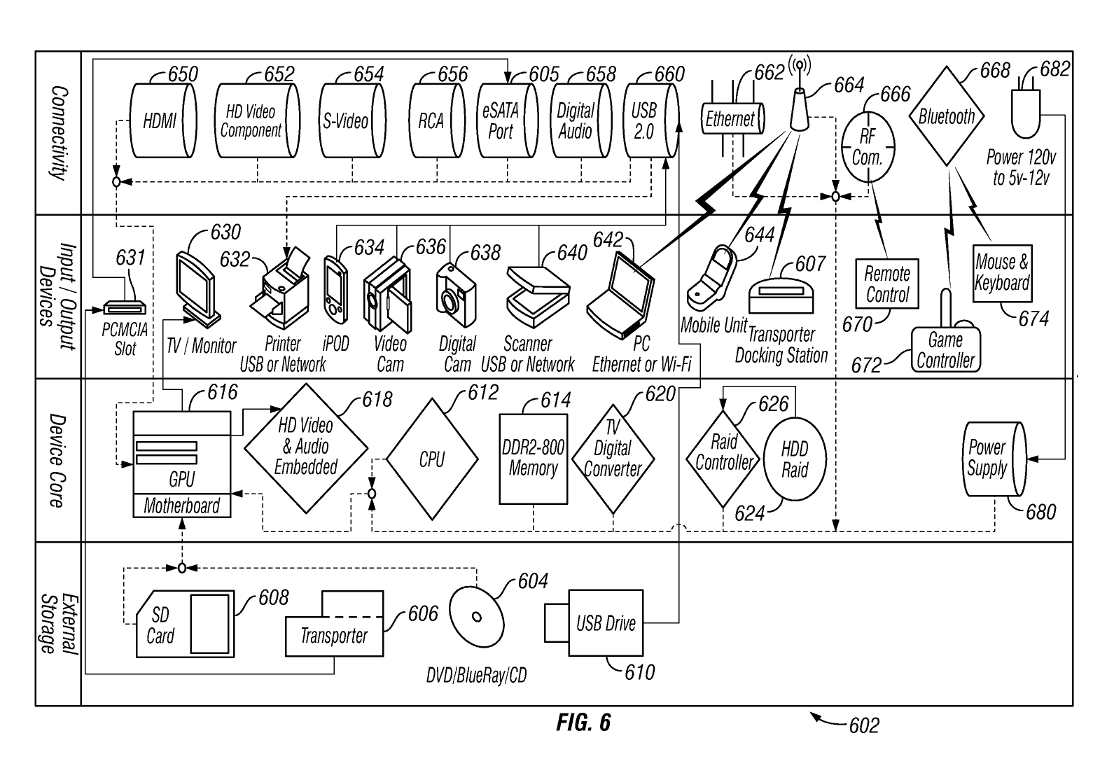

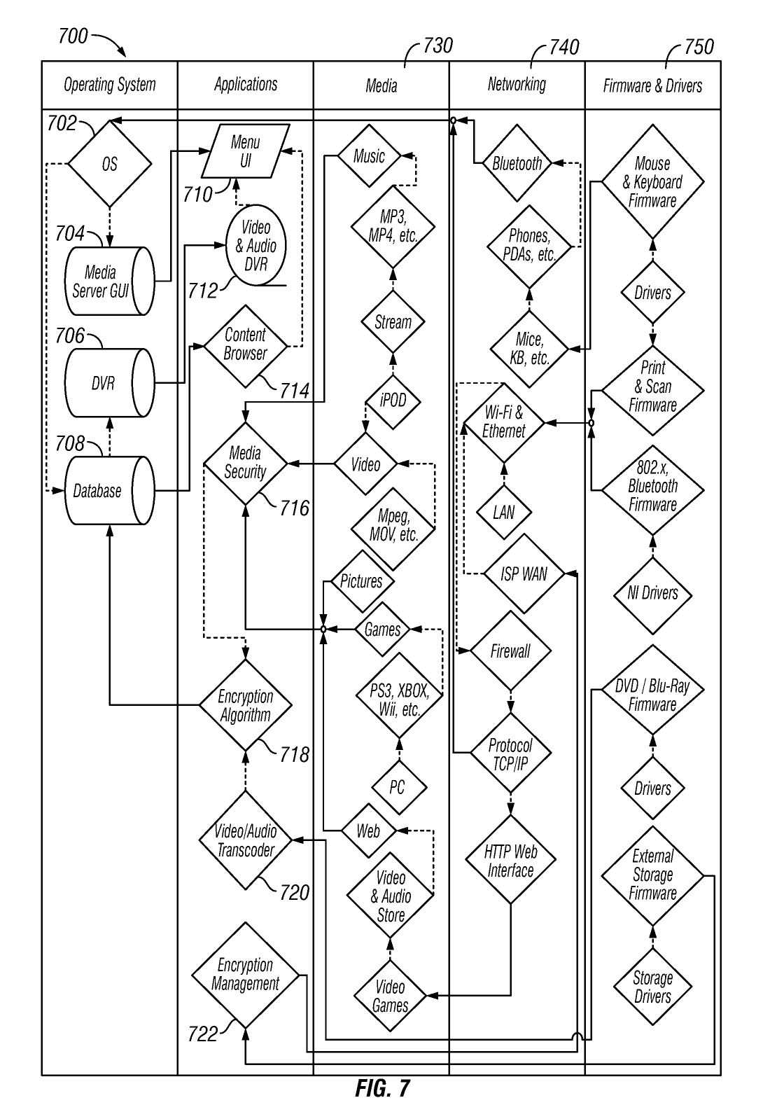

Referring now to FIG. 5, a block diagram of a preferred embodiment of the media storage and playback device of the universal multimedia distribution, storage, and playback system of the present invention, an overview of the capabilities of the device is shown. FIGS. 6 and 7, described in detail below, provide a more detailed illustration of the hardware and software used within the preferred embodiment of the device. The media storage and playback device 104 is capable of transcoding and storing information from a variety of media formats, including optical discs such as DVDs and CDs, as well as memory cards such as the media transporter device. For the purpose herein, the use of the term “transcode” or variations thereon shall be defined to include the term's ordinary meaning as well as any act of decoding for storage and playback, any information that has been encrypted or otherwise coded so as to prevent use by unauthorized persons. The ability of the media storage and playback device to read and store information from both optical discs and memory devices provides an advantage not seen in the prior art.

The media storage and playback device 104 includes a means for receiving physical media devices such, as DVDs and CDs (optical discs). In the preferred embodiment of the present invention, the media storage and playback device receives optical discs through a slot 504 on the front face of the device. Likewise, the media storage and playback, device includes a second means for receiving physical media devices containing media content. The preferred embodiment of the media storage and playback device includes a slot 505 found on the front face of the device that is configured to accept the media transporter device. In the preferred, embodiment, the slot 505 for receiving the media transporter device is a PCMCIA slot 505 that is further connected to an eSATA port (not shown). Various ports 507 on the front face of the media storage and playback device, as well as ports on the rear face (not shown) are configured to interface with a multitude of peripheral devices, such as audio output devices (speakers) 512, printers 514, digital cameras 516, remote controls 518, scanners 520, gaming controls 519, external hard drives 510, flash cards 510, SD cards 510, memory sticks 510, and video output devices 508. Alternatively, the media storage and playback device may communicate wirelessly with a smart media transporter device via an antenna 511. Additionally, the media storage and playback device is capable of receiving television programming via a television tuner card 506 and recording such information via DVR hardware and software. Once information, is received and transcoded by the media storage and playback device, the device stores the information in an internal hard drive 502. One or more external hard drives may be connected to the media storage and playback device in order to provide additional storage capacity.

The media storage and playback device 104 is capable of establishing communications with a data network 114 such as the internet 510. Thus, a user may access the World Wide Web, email, and the business and storage server through which media may be downloaded directly, without the need to interact with a media distribution kiosk. Again, the operator of the media distribution system 100 may choose to disable this capability if it is desirable to require a user to interact with a media distribution kiosk 106.

Referring now to FIG. 6, a block diagram of a preferred embodiment of the hardware 602 associated with the media storage and playback device of the universal multimedia distribution, storage, and playback system of the present invention. The device core of the media storage and playback device 104 is comprised of a number of components. Note that not all components are shown in FIG. 6, but merely those that are key to the essential functions of the device. For example, a central processing unit 612, volatile memory 61.4, a graphical processing unit 616 and embedded HD video/audio card 618, a TV digital converter 620, HD video and audio cards 622, a hard drive 624 and controller 626, and a power supply 680 are key components of the media storage and playback device.

As mentioned above, the media storage and playback device can read information from a variety of sources. Optical discs (DVD, BLU-RAY®, CD, high definition digital versatile disc (HD-DVD), etc.) 604, the media transporter device 606 (via a PCMCIA slot 631), SD cards 608, and Universal Serial Bus (USB) flash drives 610 are examples of physical media devices that the media storage and playback device will receive and transcode. Ports (HDMI 650, HD video component 652, S-Video 654, RCA 656, eSATA 605, digital audio 658, USB 2.0 660, etc.) located on the media storage and playback device support numerous peripheral, devices (television 630, printer 632, IPOD® (personal media player) 634, video camera 636, digital camera 638, scanner 640, personal computer 642, etc.). An Ethernet port provides for communications with a data network. In addition, the device is capable of wireless communications via an antenna 664/RF transceiver 666, and BLUETOOTH® 668. Exemplary devices that may communicate with the media storage and playback device through wireless means include personal computers 642, mobile phones/PDAs 644, a transporter docking station 607, remote control 670, gaming controls 672, and input devices (mouse/keyboard) 674.

Referring now to FIG. 7, a block diagram of a preferred embodiment of the software 700 associated with the media storage and playback device 104 of the universal multimedia distribution, storage, and playback system of the present invention. Linux is utilized as the operating system 702 in the preferred embodiment of the media storage and playback device 104. However, those skilled in the art will appreciate that other operating systems may be utilized in order to realize diverse capabilities. The operating system of the preferred embodiment is adapted to interface with a media server graphical user interface (GUI) that provides the user with the ability to interact with the device. A database of information that has been stored on the device also interacts with the operating system and a DVR application such as MythTV®. The foregoing capability allows the user to access both media imported from external media sources such, as optical discs/transporter device, and also television programming received by the device. Additional applications (user interlace menu 710, video/audio DVR 712, and content browser 714) provide the user with interfaces through which it may be determined what media is stored in the device and is accessible for viewing.

Optical discs containing various forms of encrypted media (movies, music, gaming software, etc.) is transcoded using software applications 720 suitable for the tasks. While the preferred embodiment of the media transporter device utilizes the publicly available HANDBRAKE® (see http://handbrake.fr) software application to transcode media supplied fay the user, it will be appreciated by those skilled in the art that other applications providing a means for transcoding encrypted information residing on physical media devices (DVDs, CDs, BLU-RAY®, etc.) may be used effectively with respect to the present invention. Alternate embodiments of the present invention may utilize other methods for transcoding and storing encrypted media residing on various physical media such as the methods taught in U.S. Patent Publication. No. 2008/0005802 A1(“DVD Identification and Managed Copy Authorization,” incorporated by reference herein. It is contemplated that the operators of the system 100 will utilize a digital rights management (DRM) system to ensure the integrity of the media being downloaded and stored on the device. For example, in an alternate embodiment of the present invention, such a digital rights management system may embed in media content downloaded by a user, information concerning the number of times the media content may be accessed or an amount of time during which the media content can be accessed. Software residing in the media storage and playback device will receive the information when the media content is transferred to the device and limit the user's access to the media accordingly.

Encryption algorithms 718 and security systems 716 will be integral to the device such that media content is not impermissibly copied by unauthorized persons. In addition, applications residing in the system will permit remote monitoring of media security and encryption management 722. Remote encryption management systems 722, for example, similar to those utilized by IronKey® systems, will provide the operator of the system with the ability to verify access to the media, disable access to the media, and destroy media content when necessary to maintain the security of the media. This advantage not seen in the prior art playback devices is key in that intellectual property owners can be confident that media used in connection with the present invention will remain secure. As previously mentioned, various forms of multimedia 730 will be accessible on the device and the device will be able to communicate with various data networks 740 to send and receive data. Firmware and other drivers 750 will enable the device to communicate with a wide variety of internal componentry and external media sources and peripheral devices.

Methods of distributing multimedia to a user in connection with the system

described above are also disclosed herein. A first method includes a step of providing a user with access to a media distribution kiosk, that is connected to a data network that is further connected to a business server on which marketing information concerning users is stored. A next step provides that the kiosk receives information, from the user concerning his or her identity. A next step provides that, the kiosk communicates with the business server via the data network to associate the user with marketing information pertaining to the user and other information. Such marketing information may include the user's media preferences, a record of past purchases of media content by the user, the user's age, the user's gender, the user's location of the user's residence, and the location of the retail establishment. A next step of the method involves the server selecting advertising information to transmit to the user based upon the user's identity and the marketing information stored on said, server. A next step of the method provides that the business server transmits information containing advertising materials to the kiosk. A final step provides that the kiosk prints and dispenses the advertising material to the user. In this manner, the present invention provides an additional advantage not seen in prior art media distribution systems. Namely, the media distribution kiosk may be utilized by the operator of the system to promote products and services within the retail establishment where the kiosk is located, or other products and services not directly associated with the retail establishment.

Another method for media distribution taught herein includes a method for transferring digital marketing content such as video or audio advertising content to a user along with the user's desired media content purchased or rented. The device used to playback the media content and marketing content would contain software to monitor and store information pertaining; to the user's playback of the marketing content. Such information would include the number of times the media content was played and, if more than one item of marketing content is transferred to the user, which marketing content item was played by the user. This information will then be transmitted to the business server via a data network, or to the kiosk via a transporter device. Based upon a user's playback of the marketing content, the user can earn a financial benefit such as discounts on future purchases of media content or other products, or monetary credits on past purchases or rentals.

For example, a media provider may choose to provide a user with the opportunity to view promotional videos such as advertisements. The advertisement media will be downloaded to the user's media transporter device simultaneously with the media specifically desired by the user. An application residing within the playback device (whether a smart transporter device or a media storage and playback device) will provide the user with the opportunity to view the advertisement media during playback of the desired media or at a different time. If viewed, information pertaining to such viewing will be transmitted to the business server via a data network. Alternatively, such information concerning the user's viewing of the advertisement media may be written back to the media transporter device such that the next time the user permits the transporter device to interact with a media distribution kiosk, said information will be uploaded to the business server. After the business server receives the information concerning the user's viewing of the advertisement media, monetary or other credits/discounts may be allocated to the user's account.

In yet another method for media distribution taught herein, a user is provided with a social networking software application that enables the user and his or her peers to share with one another, their media preferences (favorite movies, music, games, etc.). Based upon the media preferences of a user's peers, the user, using the social networking application or another software application provided to the user, can record and store his or her list of desired media content items and rank them according to their relative desirability. Information associated with the aforesaid list of desired media may be stored on the aforementioned media transport, device, the media storage and playback device, the social networking software application, or any other device or application. The list of desired media content items may then be transmitted to the kiosk or business server. One or more of the desired media items identified on the aforesaid list may then be transferred to the media transport device or media storage and playback device for later viewing. It is contemplated that the most desirable media content item on the user's list would be transferred to the user first. Information pertaining to the user's list of desired media content items (and previous lists provided by the user) may be stored on the business server. Marketing information may be provided to the user based upon the content's of the user's list of desired media content items (and previous lists provided by the user).

It will now be evident to those skilled in the art that there has been described herein, universal multimedia distribution, storage, and playback systems and methods. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A universal media distribution, storage, and playback system comprising:
a.) a media content source electronically coupled to a media distribution kiosk via a data network, said media distribution kiosk being configured to provide a user of the system with the ability to select and access media content residing at the media content source;
b.) a media transporter device having non-volatile memory that is capable of exchanging information with said media distribution kiosk, said selected media content being downloadable to said media transporter device and storable therein; and
c.) a media storage and playback device including a means for receiving an optical disc, a means for receiving said media transporter device, and a processor and associated software adapted for transcoding and playing encrypted information read from said optical disc and said media transporter device, said media storage and playback device being communicatively connected with a non-volatile memory storage system for storing said information read from said optical disc and said media transporter device.

2. The system of claim 1 wherein said media transporter device includes a processor for playback of said media content.

3. The system of claim 2 wherein said media transporter device includes a display upon which a graphical user interface (GUI) is provided, allowing a user to access information pertaining lo said media content.

4. The system of claim 3 wherein said media transporter device further includes a wireless transceiver for establishing wireless communications with the media distribution kiosk; said media distribution kiosk also including a wireless transceiver.

5. The system of claim 4 wherein said media transporter device further includes a wireless transceiver for establishing wireless communications with said data network.

6. The system according to claim 5 wherein said media transporter device is a device selected from the group consisting of: a mobile telephone, a personal digital assistant (PDA), a laptop computer, and a mobile media player.

7. The system of claim 6 wherein said wireless transceiver located on said media distribution device is capable of establishing wireless communications with a storage server that is capable of accessing said media content.

8. The system of claim 7 wherein said media storage and playback device is capable of transcoding encrypted information from a digital versatile disc (DVD).

9. The system of claim 7 wherein said media storage and playback device is capable of transcoding encrypted information from a compact disc (CD).

10. The system of claim 8 wherein said media storage and playback device further includes a wireless transceiver for establishing wireless communication with said data network.

11 The system according to claim 10 wherein said data network is a network selected from the group consisting of: a private network, mobile data network, satellite network, public switched telephone network (PSTN), and the Internet.

12. The system according to claim 12 wherein said storage system is a hard disk drive that is located within the housing of said media storage and playback system.

13. The system according to claim 12 wherein said storage system is one or more hard disk drives that are located externally to the housing of said media storage and playback system and connected for electrical communications therewith.

14. The system according to claim 12 wherein said media storage and playback device further includes at least one graphical processing unit and volatile memory for playback of video gaming software.

15. The system according to claim 12 wherein said media transporter device is an EXPRESSCARD®.

16. The system according to claim 15 wherein said means for receiving said media transporter device is a PCMCIA slot.

17. The system according to claim 12 wherein said media transporter device is a secure digital (SD) card.

18. The system according to claim 16 wherein said media transporter device further includes a communications port selected from the group consisting of: high-definition multimedia interface (HDMI), high definition video component, s-video, RCA, eSATA, digital audio, infrared (IR), universal serial bus (USB), and Ethernet.

19. The system according to claim 18 wherein said port is capable of connecting to a device selected from the group consisting of: a television, video projector, monitor, printer, personal media player device, video camera, digital camera, scanner, personal computer, notebook computer, mobile telephone, video gaming controller, remote control, keyboard, mouse, and personal digital assistant (PDA).

20. A media storage and playback device comprising:
a.) a means for receiving at least one of a physical media device having non-volatile memory upon which encrypted media content is stored, and a media device having non-volatile memory upon which media content is stored;
b.) at least one processor, volatile memory, and a means for transcoding said encrypted media content stored on said first physical media device and said media content stored on said media device;
c.) at least one storage system that is controllable by said processor; said storage system having non-volatile memory for the storage of at least said media content;
d.) a wireless transceiver for establishing communications with a data network; and
e.) a means for playback of said media content stored on said storage system.

21. The media storage and playback device of claim 20 wherein said physical media device is a device selected from a group consisting of: a digital versatile disc (DVD), compact disc (CD), BLU-RAY® disc, and high definition digital versatile disc (HD-DVD).

22. The media storage and playback device of claim 21 wherein said media device is a device selected from a group consisting of: an EXPRESSCARD®, secure digital (SD) card, memory stick, and universal serial bus (USB) flash drive.

23. The media storage and playback device of claim 21 wherein said media device includes a processor for playback of said media content.

24. The media storage and playback device of claim 23 wherein said media device includes a display upon which a graphical user interface (GUI) is provided, allowing a user to access information pertaining to said media content.

25. The media storage and playback device of claim 24 wherein said media device is a device selected from a group consisting of: a mobile telephone, a personal digital assistant (PDA), a laptop computer, and a mobile media player.

26. The media storage and playback device of claim 24 wherein said data network is a network selected from the group consisting of: a private network, mobile data network, satellite network, public switched telephone network (PSTN), and the Internet.

27. The media storage and playback device of claim 26 wherein a media content source is connected to said data network such that said media storage and playback device can establish communications therewith to receive media content.

28. The media storage and playback device of claim 27 wherein said playback of said media content is accomplished via a plurality of display devices connected to said media storage and playback device.

29. The media storage and playback device of claim 28 wherein said media content includes information pertaining to a user's authority to access said media content.

30. The media storage and playback device of claim 29 wherein said media storage and playback device limits said user's access to said media content in accordance with said information pertaining to a user's authority to access said media content.

31. The media storage and playback device of claim 27 wherein said media content is selected from a group consisting of: movies, music, television programs, ring tones, audio books, electronic books, gaming software, and media clips.

32. A method for distributing multimedia comprising the steps of:
a.) providing a user with access to a media distribution kiosk that is connected to a server on which marketing information is stored;
b.) receiving information concerning the identity of a user from said user at said media distribution kiosk;
c.) transmitting said information concerning the identity of a user from said media distribution kiosk to said server;
d.) associating said information concerning the identity of a user with said marketing information; said server selecting advertising information to transmit to said user based upon the identity of the user and the marketing information;
e.) transmitting said advertising information from said server to said media distribution kiosk; and
f.) providing said advertising information to said user.

33. The method for distributing multimedia of claim 32 wherein providing said advertising information to said user includes the media distribution kiosk printing said advertising information on a physical medium and dispensing said physical medium to said user.

34. The method for distributing multimedia of claim 33 wherein said advertising information comprises a coupon.

35. The method for distributing multimedia of claim 34 wherein said media distribution kiosk is placed in a retail establishment and said advertising information pertains to a product or service provided to consumers in said retail establishment.

36. The method for distributing multimedia of claim 35 wherein said marketing information includes information selected from a group consisting of: media preferences, record of past purchases of media content, the user's age, the user's gender, the user's location of the user's residence, and the location of the retail establishment.

37. A method for distributing multimedia comprising the steps of:
a.) providing a server through which digital media content to a user along with digital marketing content is transmitted;
b.) providing a user with a device enabled to playback said digital media content and said digital marketing content; wherein said device records information pertaining to the playback of said digital marketing content and stores said information;
c.) receiving said information pertaining to the playback of said digital marketing content at said server;
d.) storing said information pertaining to the playback of said digital marketing content;
e.) associating said information pertaining to the playback of said digital marketing content with a financial benefit to be provided to said user; and
f.) providing said user with said financial benefit.

38. The method for distributing multimedia of claim 37 wherein said financial benefit is a discount on the future purchase of digital media content.

39. The method for distributing multimedia of claim 37 wherein said financial benefit is a monetary credit on the past purchase of digital media content.

40. The method for distributing multimedia of claim 37 wherein said digital marketing content includes video media for the purpose of advertising.

41. The method for distributing multimedia of claim 37 wherein said digital marketing content includes audio media for the purpose of advertising.

42. A method for distributing multimedia comprising the steps of:
a.) providing a user with access to a social networking software application that provides said user and said user's peers with the ability to communicate to each other their respective preferences as to particular media content items;
b.) providing said user with the ability to record and store a list of desired media content items; said user indicating on said list the relative desirability of each media content item with respect to the other media content items;
e.) providing a server on which media content is stored;
d.) receiving at the server, said user's list of desired media content items; and
e.) transferring to a device controlled by the user, at least one of said desired media content items.

43. The method for distributing multimedia of claim 42 wherein said media content is selected from a group consisting of: movies, music, television programs, ring tones, audio books, electronic books, gaming software, and media clips.

44. The method for distributing multimedia of claim 43 wherein at least the most desirable media content item is transferred to said device controlled by said user.

45. The method for distributing multimedia of claim 44 further comprising the step of providing marketing information to said user based upon the contents of said list of desirable media content items.
